(19) United States
(12) Patent Application Publication
(10) Pub. No.: US 2013/0137071 A1
(43) Pub. Date: May 30, 2013

(54) Washburn Orthopedic Module (WOM)

(71) Applicant: Paul Jordan Washburn, Sodus Point, NY (US)

(72) Inventor: Paul Jordan Washburn, Sodus Point, NY (US)

(21) Appl. No.: 13/304,677

(22) Filed: Nov. 27, 2011

(51) Int. Cl. G09B 19/00

(52) U.S. Cl. 434/219

(57) ABSTRACT

I. The Washburn Ortho-Module (WOM) is a devise that is useful for orthopedic surgeons to learn and refine their tactile sense of placement of orthopedic hardware into bone that has different densities based on calculated patient age, medical history and radiological imaging (I.E., Dual-energy x-ray absorptiometry [dexa-scan], etc).

### TECHNICAL FIELD

I. Orthopedic Surgery

II. Orthopedic Surgery Residency Training

III. Orthopedic Surgical Hardware Skill Assessment

IV. Orthopedic Tool Testing and Tool selection

V. Orthopedic Scenario Training

VI. Advanced General Surgery Training

### SUMMARY OF INVENTION

I. The Washburn Ortho-Module (WOM) is a simulation module and simulated environment utilizing imitation bone and body tissue, Orthopedic Hardware (surgical devises and implants) and is used under calculated scenarios of acute and chronic trauma representing specific patients and their orthopedic complications. It is designed to train and test an Orthopedic Surgeons assessment of certain bone densities in various human populations under different presenting situations. While utilizing the WOM, a surgeon will better refine his/her tactile sense of placing surgical hardware in various anatomically precise bone and joint locations and practice placement of hardware while assessing if it is placed too rigidly or not fixed rigidly enough under the specified situations.

### Technical Problem

I. Training for Orthopedic Surgery routinely takes place in an operating room on a live patient who needs real surgery. Orthopedic surgery residency training does not typically involve a training module that allows for training mistakes in the placement of orthopedic hardware (screws/rods/plates, etc.). Scenario simulators exist in surgical training, although none are specific to training an Orthopedic Surgeon to refine his/her skills at the art of hardware placement. Orthopedic surgeons do not have a training module that allows for tightening a screw or pin to a point of maximally adhering orthopedic hardware or a training module that purposely allows, for over tightening hardware. The experimentation with trial and error for a given patient with a specific medical background is presently not available to allow the surgeon to tactilely feel the stripping of the screw taking place and thus refine the skill of not stripping hardware placed in/on a live person. This combination of knowing the patients' bone and medical history, allowing the surgeon to test how much force is needed to properly tighten hardware without doing more harm, and lastly to purposefully allow more harm in a controlled environment to know the bone/patients physiological limitations is crucial for a thorough training of an orthopedic surgeon.

### Solution to Problem

I. The WOM is designed to allow a surgeon to use the common tools located in an operating room to test hardware placement in multiple simulated scenarios. The WOM has two different design options. Both designs allow a surgeon to tactilely train in the placement of orthopedic hardware in a simulated environment.

II. Design Options:
A. Mechanical Torque Wrench: The first design is mechanical in nature and based on already designed, common knowledge torque wrench mechanisms. The desired torque is calculated based off of variable the patient presents with and the devise is adjusted to be comparable to these variables (not limited to the following: bone mineralization, age, fragmentation force, nutritional history, DEXA-scan results, trauma history, etc.) for a given patients presentation. The torque adjustment then varies with the calculation number achieved by utilizing the above variables.
B. Bio-mineral/Bio-ceramic Preformed Synthetic Human Bone Cake: The second design involves prefabricated bio-mineral/bio-ceramic cakes that are designed to have a consistency mimicking various bone densities and fragmentation rates. These correlate to bone densities of different patients based on variables stated previously.

III. The surgeon can then experience multiple hardware placement scenarios without having the fear of causing undue injury to a live patient during a surgery. By utilizing simple orthopedic tools (I.E., orthopedic screwdriver or drill) the surgeon can practice turning a screw to such a tightness that ranges from loose hardware to complete stripping of the simulated placed hardware. This practice allows the surgeon to experience a complete spectrum of hardware placement for learning purposes without compromising real patients bone matrix during surgery or real hardware which is quite expensive both in material and preparation.

### Advantageous Effects of Invention

I. By utilizing the WOM, a surgeon in training will learn placement of hardware on synthetic human bone allowing refinement of their tactile skills regarding hardware placement along with limitations of such placement. With knowing the specific bone densities and experiencing what it feels like to place hardware into synthetic bone, the surgeon can not only better predict the effects of hardware placement during a real orthopedic surgery, but also better assess the predisposition of bone to stresses achieved during surgery. This in turn reduces surgical complications secondary to inexperience regarding “the art of surgical feel” which truly comes only with surgical experience.

### BRIEF DESCRIPTION OF DRAWINGS

I. The attached drawings depict the WOM.
a. Page #1 depicts a platform with a mechanical torque device attached as viewed from the top and side. A view with the preformed prosthetic is also present. The incisions when opened may show the major superficial and deep tissues that need to be moved in order to make the hardware placement possible.
b. Page #2 depicts the Bio-Medical Synthetic bone cake as a side view, top view and is depicted inserted into the base plate with prosthetic limb attached as a single simulation unit.
c. Page #3 depicts an example of a view inside an incision utilizing a specific approach (Moore Approach) and using both the mechanical torque device and the Bio-medical Cake as a means for simulation.

### DESCRIPTION OF EMBODIMENTS

I. The WOM is made from metals, plastics, foams, leathers, bio-ceramics and bio-minerals. A base platform is attached to the torque devise. The torque devise is stationary while the prosthetic body parts are interchangeable on top of the base platform. This gives the desired simulated experience while training on multiple interchangeable body parts. The prosthetic body parts have an opening incision to retract the prosthetic skin which mimics a true surgical incision, allowing a view inside the prosthetic, which have multiple incisions in locations targeted for “high yield” simulated orthopedic surgical training. It is in these incision spots at the synthetic bone where the training simulation of placing hardware to bone is to be implemented.

II. The central device incorporates the following two methods, and not limited to the following 2 methods, of simulating hardware placement in a synthetic bone medium. The first is via utilizing a version of and not limited to a torque slip clutch or friction plate clutch or a version of the pawl and spring torque clutch which will “slip” when a certain desired torque is applied to it, as will bone when a force greater than the strength of the bone is applied to hardware being placed into it. This torque will be applied when the surgeon or trainee turns, with an orthopedic screw driver or via orthopedic drill in hand, the female or male end of the torque device head. This will allow torque to be increased and simulate the given strength of the bone desired via calibration prior to adding torque with said tool, which is the simulated training concept desired for the WOM. The other version of the device is via insertable cartridges that can be any shape or size, and comprised of Bio-Minerals and or Bio-Ceramics. These are materials that represent bone at certain densities, meaning they are calculated and generated to have physical densities comparative to bone densities which will represent patients at different ages and with different medical conditions and traumas. These cartridges will allow a surgeon in training to actually screw/drill into material similar to bone of a given patient and allow the surgeon in training to place hardware into the cartridge material, gaining invaluable experience before hardware placement in a real patient with the same bone constellation.

### The Assembly of the Device

I. The torque device is calibrated via calculation and adjustment to a desired torque value based on the desired testing scenario for specific bone density. Preformed body prosthetics are placed on top of the torque device and locked down via clasp, strap or pining mechanism (this gives a varied, simulated, surgical patient experience to the trainee). If the bio-ceramic cartridge device is used, the platform is still utilized and the cartridge is adhered to the under part of the prosthesis near the incision, or it is fixed to the top of a spacer that is attached to the platform. Both versions create an option for the cartridge to be seen from inside the prosthesis via the viewable access point, the incision, during simulated hardware placement.

### INDUSTRIAL APPLICABILITY

I. Healthcare, Orthopedic Surgery training, General Surgery, Advanced training in General Surgery.

### REFERENCE SIGNS LIST

I. None included with this patent application

### Reference to Deposited Biological Material

I. None included with this patent application

### SEQUENCE LISTING FREE TEXT

I. None are included with this patent application

### CITATION LIST

I. Patent Literature—None included with this patent application

II. Non-Patent Literature—None included with this patent application

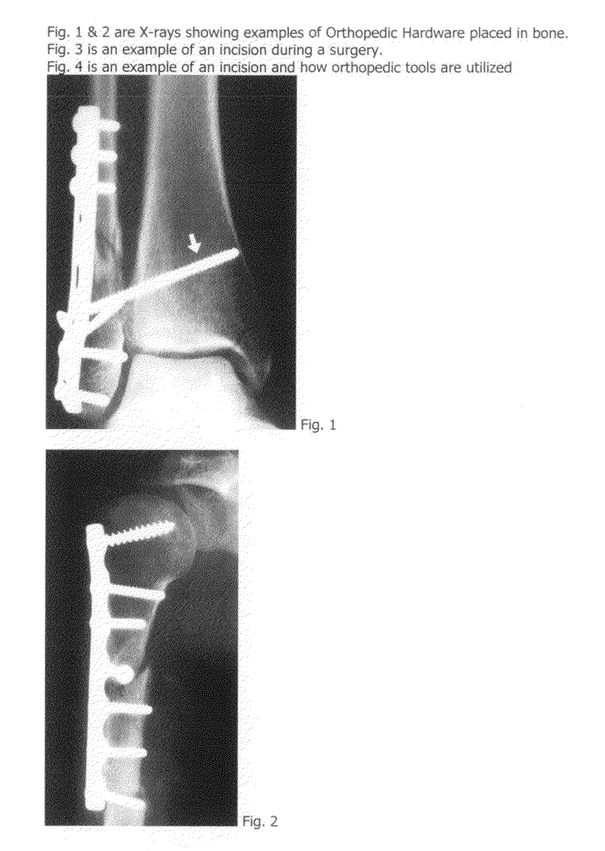

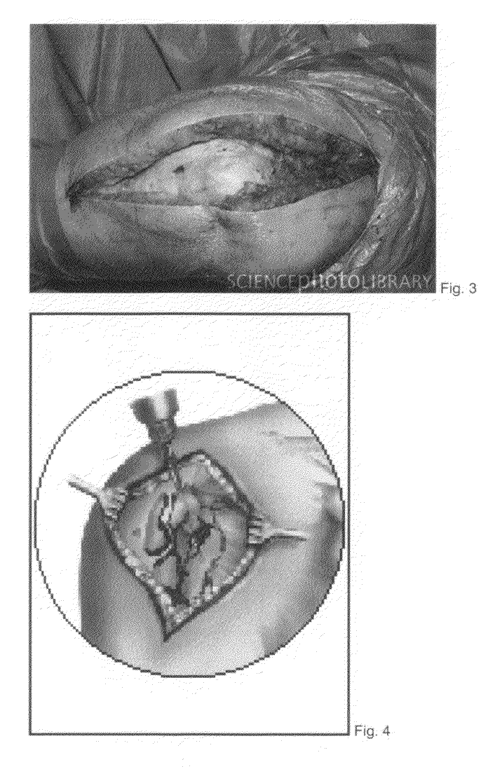

### DRAWINGS AND PHOTOS

| | | |
|---|---|---|
| I. | Attachment #1, | Brief views of WOM |
| | pg. 11 | |
| II. | Attachment #2, | Brief views of prosthetic parts used in WOM |
| | pg. 12 | |
| III. | Attachment #3, | Brief Views of incision and inner compartment |
| | pg. 13 | containing various synthetic tissues and the |
| | | torque device |
| IV. | Background Art, | |
| | pg. 14-15 | |
| | a. FIGS. 1-4: | Brief views of what surgical hardware looks like |
| | | in real surgical cases, as to visually describe |
| | | what hardware looks like adhered to human |
| | | bone via radiographs and what the incision |
| | | would look like during actual surgical |
| | | proceedings. Photographs. |

### SEQUENCE LISTING

None included with this patent application

### Incision Rubric:

The following is a list of Incisions useful for viewing the torque devices located inside the prosthetic body parts once the WOM is assembled.

I. Pelvic: accetabulum
A. Anterior approach: LeTournel & Judet iliofemoral approach
   1. Landmarks: ASIS/Iliac crest/anterior thigh
   2. Incision: Curved longitudinal incision, Runs along the anterior half of the iliac crest to the ASIS, Then vertically down anterior thigh for 8 cm
   3. Extra care for: Nerves (Lateral femoral cutaneous nerve, Femoral nerve) Vessels (Ascending branch of lateral femoral circumflex artery, Superior gluteal artery)
B. Ilioinguinal approach: exposure of inner surface of pelvis from the sacroiliac joint to pubic symphysis and anterior & medial surfaces of acetabulum
   1. Landmarks:ASIS/pubic tubercles
   2. Incision: Curved anterior incision, begin incision 5 cm above the ASIS extending medially passing 1 cm above the pubic tubercle, Ending the incision midline
   3. Extra care for: Nerve (Femoral, Lateral cutaneous nerve of thigh, Vessels (Femoral, Inferior epigastric artery & vein), Spermatic cord, Bladder
C. Posterior approach: To expose the posterior aspect of the acetabulum
   1. Landmarks: Greater trochanter, Iliac crest
   2. Incision: Longitudinal incision centred over greater trochanter, Starts just below iliac crest and Ends 10 cm below tip of greater trochanter
   3. Extra care for: Nerves (Sciatic, Inferior gluteal), Vessels (Inferior & superior gluteal artery), Heterotropic ossification (Increased with acetabular fractures & trochanteric osteotomy

II. Hip:
A. Anterior Hip Approach: Smith Peterson Approach
   1. Landmarks: ASIS/Iliac crest
   2. Incision: Curved longitudinal incision, Runs along the anterior half of the iliac crest to the ASIS, Then vertically down anterior thigh for 8 cm
   3. Extra care for: Nerves (Lateral femoral cutaneous, Femoral), Vessels (Ascending branch of lateral femoral circumflex artery)
B. Anteriolateral approach: Watson Jones Approach
   1. Landmarks: ASIS/Greater trochanter/Shaft of femur
   2. Incision: Flex the hip 30° & adduct, perform a 15 cm straight longitudinal incision centered over the tip of the greater trochanter
   3. Extra care for: Nerve (Femoral nerve), Vessels (Femoral artery & vein and Profunda femoris artery)
C. Ilioinguinal approach to the hip: Good for exposure of the acetabulum & pelvis distal to the iliopectineal eminence, access to the inner ilium, inner surface of the true pelvis & SIJ, expose outer surface of ilium by releasing the abductors
   1. Landmarks: ASIS/Pubic Symphysis/Illiac Crest/Gluteus Medius
   2. Incision: 2 incisions, medial limb—2-3 cm above symphysis pubis to ASIS, lateral limb—extends fro ASIS to beyond the Gluteus Medius tubercle of the iliac crest
   3. Extra Care for: spermatic cord, femoral nerve, Iliopsoas and femoral nerve
D. Lateral Approach to Hip: Good for direct lateral/Transgluteal/Hardinge approach:
   1. Landmarks: ASIS/Iliac crest/Greater trochanter/Femoral shaft
   2. Incision: Perform a 15 cm longitudinal incision centered over the tip of the greater trochanter
   3. Extra Care For: Nerves (Superior gluteal and Femoral nerve), Vessels (Femoral artery & vein, Lateral circumflex artery)
E. Medial Approach to the Hip: Ludloff approach:
   1. Landmarks: Adductor Longus, Pubic Tubercle
   2. Incision: Perform a Longitudinal incision on the medial side of side centred over the adductor longus. Start 3 cm below pubic tubercle and the end length of the incision is to be determined by amount of femur needed to be exposed.
   3. Extra Care For: Nerves (anterior and posterior division of obturator), Vessels (medial femoral circumflex artery)
F. Posterior approach to the hip: Moore Approch:
   1. Landmarks: Greater Trochanter, PSIS, Iliac crest, Shaft of femur
   2. Incision: Perform a 15 cm curved incision centered on the posterior aspect of greater trochanter and PSIS and Start 8 cm above & posterior to the posterior aspect of the greater trochanter while ending the incision at a desired length down the shaft of femur.
   3. Extra care for: Nerves (Sciatic), Vessels (Inferior gluteal and Lateral circumflex artery)

III. Knee:
A. Lateral Approach to the Knee
   1. Landmarks: Lateral border of patella/Lateral joint line/Gerdy's tubercle (Inferior attachment of iliotibial band)
   2. Incision: Perform a curved longitudinal incision starting 3 cm lateral to and at the middle level of the patella, over Gerdy's tubercle and end 5 cm distal to the joint line
   3. Extra Care for: Nerve (Common peroneal nerve), Vessels (Lateral superior geniculate artery between lateral head of gastrocnemius & posterolateral capsule), Popliteus tendon
B. Medial approach to the Knee
   1. Landmarks: adductor tubercle (medial surface of MFC posteriorly)
   2. Incision: Perform a curved longitudinal incision starting 2 cm proximal to the adductor tubercle of the femur curving anteroinferiorly and ending 6 cm below the joint line on the anteromedial aspect of tibia
   3. Extra care for: Nerves (Infrapatella branch of saphenous nerve), Vessels (Saphenous vein, Medial inferior genicular artery, Popliteal artery)
C. Medial Parapatellar approach to the Knee
   1. Landmarks: Patella, Patellar ligament, Tibial tuberosity
   2. Incision: Perform a straight longitudinal midline incision starting from 5 cm above the superior pole of patella and ending at the level of tibial tubercle
   3. Extra care for: Patellar tendon and Ligament
D. Posterior approach to the Knee: Primarily a neurovascular approach
   1. Landmarks: Gastrocnemius (two heads), Semimembranosus & Semitendinosis, Biceps tendons
   2. Incision: Perform a longitudinal curved incision starting laterally over the biceps femoris muscle curving slightly obliquely across the popliteal fossa and ending over the medial head of the gastrocnemius
   3. Extra Care For: Nerves ((Medial sural cutaneous, Tibial and Common Peroneal nerve), Vessels (Small Saphenous vein)

IV. Tibia/Fibula:
A. Anterior Approach to the Tibia:
   1. Landmarks: Shaft of tibia
   2. Incision: Perform a straight longitudinal incision on the anterior surface of the leg parallel & 1 cm lateral to anterior border of tibia
   3. Extra Care For: Vessels (Greater saphenous vein, Long saphenous vein on medial side of calf
B. Anterolateral Approach to the Tibia: Useful approach when anterior 2/3 of leg are not accesable due to integument complications via anterior approach
   1. Landmarks: Subcutaneous surface of fibula, Fibular head, Tibial shaft
   2. Incision: Perform a straight longitudinal incision over the shaft of the fibula
   3. Extra Care For: Nerves (Superficial peroneal nerve), Vessels (Small saphenous vein)
C. Posteriolateral Approach to the Tibia: Usefull approach when anterior 2/3 of leg are not accessible due to integument complications via anterior approach
   1. Landmarks: Lateral border of gastrocnemius
   2. Incision: Straight longitudinal incision over lateral border of gastrocnemius muscle
   3. Extra Care For: Nerves (Peroneal, Saphynis), Vessels (Short saphenous vein, Branches of peroneal artery, Posterior tibial artery)
D. Fibular approach
   1. Landmarks: Head and shaft of Fibula
   2. Incision: Perform a straight longitudinal incision just posterior to the fibula, starting at the lateral malleolus and ending at the fibular head
   3. Extra Care For: Nerves (Common peroneal nerves), Vessels (Terminal branches of peroneal artery near lateral malleolus)

V. Ankle:
A: Anterior approach to Ankle:
   1. Landmarks: Medial and lateral malleolus
   2. Incision: Perform a 15 cm straight longitudinal incision centered midway between the malleoli
   3. Extra Care For: Nerves (Superficial and deep peroneal), Vessels (Anterior tibial artery)
B. Lateral Malleolus approach to the Ankle: Useful for exposure to mallus for Fracture Fixation
   1. Land marks: Subcutaneous surface of fibula and Lateral Malleolus
   2. Incision: Perform a 10-15 cm incision along the posterior margin of the fibula
   3. Extra Care For: Nerve (Sural) Vessel (Terminal branches of peroneal artery)
C. Medial Approach to the ankle: Useful for arthrodesis, excision of osteochondral fragments from medial side of talus, removal of loose bodies
   1. Land marks: Medial Malleolus
   2. Incision: Perform a 10 cm longitudinal incision centered over the tip of the medial malleous starting on the medial surface of the tibia and ending on the medial cuneiform
   3. Extra Care For: Nerves (Saphenous) Veins (Long saphenous), Tendons (Tibialis posterior)
D. Posteriomedial approach to the anckle: Useful for CLub Foot
   1. Land marks: Medial malleolus, Achilles tendon
   2. Incision: Perform a 10 cm longitudinal incision midway between the medial malleolus & the achilles tendon
   3. Extra Care For: Nerve (tibial), Vessels (Posterior tibial artery)
E. Posteriolateral approach to the ackle: Useful for ORIF of posterior malleolar fracture, Excision of sequestra, Removal of benign tumours, Arthrodesis of posterior facet of subtalar joint, Posterior capsulotomy & syndesmotomy of ankle, Elongation of tendons
   1. Land marks: lateral malleolus, achilles tendon
   2. Incision: Perform a 10 cm incision halfway between posterior border of lateral malleolus & Lateral border of achilles tendon starting level with tip of fibula and extend it proximally
   3. Extra Care For: Verve (Sural), Vessels (Short saphenous)

VI. Foot:
A. Lateral Approach to hind foot: Useful for exposure of talocaneonavicular joint, posterior talocalcaneal Joint, calcaneocuboid joint, arthrodesis
   1. Land marks: lateral malleolus, lateral wall of calcaneus, sinus tarsi
   2. Incision: perform a curved incision starting just distal to the distal end of the lateral malleolus going over the sinus tarsi curving medially and ending at the talocalcaneonavicular joint.
   3. Extra Care For: Skin flap necrosis

VII. Hand and wrist:
A. Midlateral approach to flexor tendon sheath:
   1. Land marks: Proximal interphalangeal crease, Distal interphalangeal crease, Junction between volar smooth skin & dorsal sking crease
   2. Incision: Perform a direct dorsolateral longitudinal incision (junction of smooth & skin crease)
   3. Extra Care For: Nerve (Palmer digital), Vessel (Volar digital artery)
B. Volar approach to the flexor tendons:
   1. Land marks: Skin creases, Distal Interphalangeal crease, Just proximal to DIPJ, Proximal interphalangeal crease, Just proximal to PIPJ, Palmer digital crease, distal to the MPJ
   2. Incision: Make zigzag incision, 90° to each other, angled at each skin crease, not to far dorsal as endangers neurovascular bundle
   3. Extra Care For: Digital nerves & vessels, Necrosis of skin flaps, Avoid 90° angles across skin creases, leads to contractures

VIII. Forearm:
A. Approach to anterior. Radius:
   1. Land marks: Biceps tendon, mobile wad (BR ECRL ECRB), styloid process of radius,
   2. Incision: Perform a straight longitudinal incision starting in the anterior flexor crease of the elbow just lateral to biceps tendon and ending at the styloid process of the radius
   4. Extra Care For: Nerves (PIN, Superficial radial), Vessels (Radial and Recurrent radial arteries)
B. Posterior approach to the forearm (Thmpson approach)
   1. Land marks: Lateral epicondyle of humorous, Lister's tubercle
   2. Incision: Perform a straight Longitudinal incision starting anterior to the lateral epicondyle and ending just distal to Lister's tubercle (dorsal distal radial head)
   3. Extra Care For: Preserve the PIN
C. Approach to the Ulna:
   1. Land marks: Subcutaneous border of the ulna
   2. Incision: Linear longitudinal incision over subcutaneous border of ulna
   3. Extra Care For: Nerves (Ulnar), Vessels (Ulnar artery)

IX. Elbow:
A. Anterior approach to the Cubital Fossa: Usefull for reinsertion of biceps tendon, release of anterior capsular contractions, Repair of nerves
   1. Land marks: Brachioradialis, Tendon of biceps, Anterior elbow crease
   2. Incision: Perform a curved longitudinal S shaped incision over the anterior aspect of olecranon process, starting 5 cm above elbow crease on the medial side of the biceps, Cross the elbow crease obliquely, and ending on the medial border of the brachioradialis.
   3. Extra Care For: Nerve (Lateral cutaneous nerve of forearm), Vessels (radial artery, PIN)
B. Aneriolateral approach (Henry's Approach): Useful for exposure of lateral half of elbow joint, capitellum, Proximal third of anterior aspect of radius, ORIF, Biceps avulsion, septic arthritis and drainage, decompression, Arcade of Frohse, PIN, Total elbow replacements.
   1. Land marks: Brachioradialis, Biceps tendon, Anterior elbow crease
   2. Incision: Perform a 15 cm Curved longitudinal gentle S shaped incision along the anterior aspect of elbow starting 5 cm above the elbow crease over lateral border of the biceps Crossing the elbow crease obliquely and ending at the medial border of the brachioradialis
   3. Extra Care For: Nerves (Radial, PIN, Lateral cutaneous nerve of forearm), Vessels (Radial artery, Recurrent branches of radial artery)
C. Media approach via medial epicondyl osteotomy: Useful for ORIF
   1. Land marks: Medial epicondyle
   2. Incision: Perform a 10 cm longitudinal incision centered over the medial epicondyle
   3. Extra Care For: Nerves (Ulnar, Median)
C. Posterior approach to elbow using olecrenon osteotomy: useful for ORIF of the distal humerus, Removal of Loose bodies, non-unions
   1. Land marks: Olecranon process
   2. Incision: Perform a 10 cm longitudinal midline incision along the posterior aspect of the elbow and curve the incision laterally around the olecrenon process
   3. Extra Care For: Nerves (Ulnar, Radial, Median) Vessels (Brachial artery)

X. Arm/Humerous:
A. Anterior approach to the Humerous
   1. Land marks: coracoid process, long head of the biceps
   2. Incision: Perform a Longitudinal incision along the deltopectoral groove & lateral border of the biceps, starting at the coracoid process
   3. Extra Care For: Nerves (Radial, Axillary), Vessels (Anterior humeral circumflex)
B. Anterolateral approach to the distal humerous: useful for view of the distal 4th of humerus, ORIF, Exploration of radial nerve
   1. Land marks: biceps, anterior flexion crease of elbow
   2. Incision: Perform a curved longitudinal incision along lateral border of the biceps starting 10 cm above the elbow crease and ending just above the elbow crease
   3. Extra Care For: Nerves (lateral cutaneous nerve of forearm, radial nerve)
C. Lateral approach to the distal humerous: Useful for Lateral epicondyle ORIF or Tennis elbow
   1. Land marks: Lateral epicondyle, lateral supracondylar ridge
   2. Incision: Perform a 5 cm longitudinal incision centered over the lateral supracondylar ridge
   3. Extra Care For: Nerve (radial)
D. Minimal access approach to proximal humerous: useful for insertion of a humeral nail
   1. Land marks: Acromion
   2. Incision: Perform a 2 cm longitudinal incision starting at the outer aspect of the acromion
   3. Extra Care For: Nerves (Axillary), Tendons (supraspinatus)
E. Posterior approach to the humerous: Useful for ORIF, Osteomyelitis, Exploration of radial nerve
   1. Land marks: Acromion, Olecranon fossa
   2. Incision: Perform a longitudinal midline incision starting 8 cm below the acromion and ending at the olecranon fossa
   3. Extra Care For: Nerve (Radial, ulnar), Vessels (Profunda brachii artery)

XI. Shoulder:
A. Anterior approach
   1. Land marks: Clavicle, Acromion, Coracoid process, Deltopectoral groove
   2. Incision:
      A. Anterior incision—perform incision starting just above the coracoid process, 10-15 cm along line of deltopectoral groove
      B. Axillary incision—abduct shoulder 90° & ER, perform incision starting at the midpoint of anterior axillary skin fold, then a vertical incision 8-10 cm, ending towards axilla
   3. Extra Care For: Nerve (Musculocutaneous nerve), Vessels (Cephalic vein)
B. Anterolateral approach to shoulder:
   1. Land marks: Clavicle, Acromion, Spine of scapular, Coracoid process
   2. Incision: Perform a transverse incision starting at the anterolateral corner of the acromion and ending just lateral of the coracoid process
   3. Extra Care For: Nerve (Axillary), Vessel (Acromial branch of coracoacromial artery)
C. Lateral approach to the shoulder
   1. Land marks: Acromion, Clavicle, Spine of scapula
   2. Incision: Perform a 5 cm longitudinal incision starting at the tip of the acromion and ending down the lateral aspect of the arm
   3. Extra Care For: Nerve (axillary)
D. posterior approach to the Shoulder
   1. Land marks: Acromion and spine of the scapula
   2. Incision: Perform an incision along the line of the spine of the scapula to the lateral border of the acromion, the medial end can be curved distally to enhance the exposure,
   3. Extra Care For: Nerve (axillary), Vessels (posterior circumflex humeral)

1. This patent is to protect the WOM in clear purpose as an apparatus for training Orthopedic Surgeons to refine their orthopedic hardware placing skills by utilizing a simulation module containing two types of torque devices that can be calibrated to a specific torque for added tactile experience.
